(19) United States
(12) Patent Application Publication
(10) Pub. No.: US 2025/0170627 A1
(43) Pub. Date: May 29, 2025

(54) MAGNETIZATION PYROLYSIS DEVICE FOR ORGANIC WASTE AND USING METHOD THEREOF

(71) Applicants: Nankai University, Tianjin (CN); Kashi University, Kashi City (CN); Tianjin Sinotech Environmental Technology Development Co., Ltd., Tianjin (CN)

(72) Inventors: Weizun LI, Tianjin (CN); Mingyan YU, Tianjin (CN); Tao SUN, Tianjin (CN); Zhentong LIU, Tianjin (CN); Xianghao ZHA, Tianjin (CN)

(73) Assignees: Nankai University, Tianjin (CN); Kashi University, Kashi City (CN); Tianjin Sinotech Environmental Technology Development Co., Ltd., Tianjin (CN)

(21) Appl. No.: 18/404,040

(22) Filed: Jan. 4, 2024

(30) Foreign Application Priority Data
Nov. 23, 2023 (CN) 2023115724791

(51) Int. Cl. B09B 3/50; B09B 3/35; B09B 101/25

(52) U.S. Cl. CPC B09B 3/50; B09B 3/35; B09B 2101/25

(57) ABSTRACT

A magnetization pyrolysis device for organic waste and a using method thereof are provided. During the magnetization pyrolysis of organic waste, the device uses perovskite as a catalyst, and includes a crushing reaction chamber combining a crushing zone with a reaction zone; a crushing mechanism for crushing waste; and a heating mechanism for heating the waste, the crushing mechanism and the heating mechanism are arranged in the crushing reaction chamber. In accordance with the present disclosure, the crushing zone is combined with the reaction zone, which significantly reduces the treatment space and cost. In-situ degradation of household waste can be achieved by the device without leaving the village, and the daily cleaning of everyday rural waste can be effectively achieved.

### CROSS-REFERENCE TO RELATED APPLICATION

This patent application claims the benefit and priority of Chinese Patent Application No. 202311572479.1 filed with the China National Intellectual Property Administration on Nov. 23, 2023, the disclosure of which is incorporated by reference herein in its entirety as part of the present application.

### TECHNICAL FIELD

The present disclosure relates to the technical field of waste treatment equipment, and in particular to a magnetization pyrolysis device for organic waste, and a using method thereof.

### BACKGROUND

At present, the bottlenecks and problems in rural household waste treatment are mainly caused by incomplete infrastructure construction and high investment cost. Although a three-stage treatment mode of “village collection, township transportation and county treatment” has been formed, from the perspective of economic cost, the existing waste collection and treatment model has the problems of long transportation distance, large amount of land for treatment, high collection and transportation costs and high infrastructure construction costs due to the large rural area and scattered waste distribution. From the perspective of social and environmental impact, arbitrary dumping and stacking of household waste, as well as the inability to clear the waste up in time can easily cause secondary pollution to the surrounding environment, including water bodies, soil, air, etc., breed mosquitoes and flies, and stink to high heaven, which seriously affects the rural living environment, and also lays hidden dangers for the personal health of villagers. From the perspective of treatment technological means, due to the high transportation and collection costs of waste and the low waste output, a 5 t/d waste incineration facility, which has been built already, cannot operate normally. Landfill takes up a lot of land resources, and the cost of seepage prevention and leachate treatment is high. The reduced landfill treatment is currently supported in China, so the direct landfill of household waste is no longer suitable for the current social development in China.

Technical methods for degrading organic waste by electromagnetic field technology can alleviate the bottlenecks and problems existing in rural household waste treatment to some extent. However, although the degradation temperature of waste treatment is reduced in the degradation of organic waste by electromagnetic field technology, the equipment for degrading organic waste by electromagnetic field technology in the prior art occupies a large space and has a complex equipment composition, since a crushing zone is usually separated from a reaction zone. Thus, how to further simplify the equipment structure and reduce the occupied space has become an urgent problem to be solved.

### SUMMARY

An objective of the present disclosure is to provide a magnetization pyrolysis device for organic waste, and a using method thereof, so as to solve the problems in the prior art. In the present disclosure, a crushing zone is combined with a reaction zone, which significantly reduces treatment space and cost.

To achieve the objective above, the present disclosure provides the following technical solution:
A magnetization pyrolysis device for organic waste, configured for magnetization pyrolysis process of organic waste using perovskite as a catalyst, the magnetization pyrolysis device includes a crushing reaction chamber combining a crushing zone with a reaction zone; a crushing mechanism for crushing the organic waste; and a heating mechanism for heating the organic waste, the crushing mechanism and the heating mechanism are arranged in the crushing reaction chamber.

Preferably, the crushing mechanism includes a stirring shaft traversing the crushing reaction chamber, and blades uniformly arranged on an outer circumference of the stirring shaft. Exhaust gas circulation channels are formed inside the stirring shaft and the blades and are in communication with each other. Vent holes for communicating the exhaust gas circulation channels with outside are formed in the blades.

Preferably, an exhaust gas outlet is formed at a top of the crushing reaction chamber, the exhaust gas outlet is in communication with an exhaust gas purification system for purifying exhaust gas by a pipeline, and the exhaust gas purification system is connected to a negative pressure fan for extracting exhaust gas from the crushing reaction chamber.

Preferably, an exhaust gas recycling mechanism is arranged on the pipeline between the exhaust gas outlet and the exhaust gas purification system, and the exhaust gas recycling mechanism is in communication with the exhaust gas circulation channel in the stirring shaft.

Preferably, the heating mechanism includes an electromagnetic induction heating assembly, and the electromagnetic induction heating assembly forms a high-frequency magnetic field with a neodymium magnet by alternating voltage.

Preferably, an infrared temperature measuring device and a laser range finder are arranged in an upper part the crushing reaction chamber.

A using method of the magnetization pyrolysis device for organic waste above includes the following steps:
Step (1) turning on the negative pressure fan and the exhaust gas recycling mechanism to maintain the exhaust gas purification system in a micro-oxygen state, opening a feed port of the crushing reaction chamber, pouring collected household waste mixture into the crushing reaction chamber in batches until height of the waste mixture is 20 cm-30 cm higher than that of the crushing mechanism, and mixing the household waste mixture with a perovskite catalyst;
Step (2) closing the feed port, and turning on the crushing mechanism for 3 min-7 min;
Step (3) turning off the crushing mechanism, turning on the electromagnetic induction heating assembly to enable the organic waste to perform self-heating by electromagnetic radiation;
Step (4) detecting reaction temperature by the infrared temperature measuring device, and turning off the electromagnetic induction heating assembly when the reaction temperature reaches a certain temperature, and turning on the electromagnetic induction heating assembly when the reaction temperature is lower than the certain temperature;
Step (5) maintaining heating reaction for 20 h-24 h; and
Step (6) turning off the negative pressure fan, the exhaust gas recycling mechanism and the electromagnetic induction heating assembly, opening the feed port for feeding, and repeating above steps.

Preferably, the reaction temperature is 200° C.-250° C.

Preferably, amount of the perovskite catalyst added accounts for 1%-5% of mass of the organic waste.

Preferably, an oxygen concentration in the micro-oxygen state is 0.01 ml/L-0.1 ml/L.

Compared with the prior art, the present disclosure achieves the following beneficial technical effects:
In the present disclosure, the crushing zone is combined with the reaction zone, which significantly reduces treatment space and cost. In-situ degradation of household waste can be achieved by the device without leaving the village, and the daily cleaning of everyday rural waste can be effectively achieved. Also, the device can selectively decompose organic components in the household waste mixture, without inorganic components participating in the reaction, which also provides a new path for classification of rural household waste.

Other technical solutions provided in the present disclosure also have the following technical advantages.

In the prior art, the crushing zone is usually separated from the reaction zone, this is because the required temperature for degradation reaction is relatively high, and other components affected by high temperature, such as the crushing mechanism, cannot be arranged in the reaction zone to prevent the high temperature from affecting the performance and service life of the shaft, blades and other parts of the crushing mechanism. However, in the present disclosure, perovskite is used as a degradation catalyst, such that the organic waste can be decomposed and mineralized under the condition of not exceeding 250° C., the required reaction temperature is greatly reduced, the requirements for the high-temperature resistance, corrosion resistance and other performances of equipment parts in the reaction chamber are lowered, and the crushing zone is combined with the reaction zone.

By using perovskite as a catalyst, the activation energy of the organic waste can be reduced when mixed with the organic waste, thus lowering the degradation temperature of the organic waste, shortening the degradation time and avoiding the production of dioxins. Experimental results show that the perovskite catalyst provided in the present disclosure can complete the degradation of the organic waste within 24 h at 200° C.-250° C. when applied to electromagnetic degradation of the organic waste.

### BRIEF DESCRIPTION OF THE DRAWINGS

To describe the technical solutions in the embodiments of the present disclosure or in the prior art more clearly, the following briefly introduces the accompanying drawings required for describing the embodiments. Apparently, the accompanying drawings in the following description show merely some embodiments of the present disclosure, and those of ordinary skill in the art may still obtain other drawings from these accompanying drawings without creative efforts.

FIG. 1 is a structural schematic diagram of a magnetization pyrolysis device for organic waste according to an embodiment of the present disclosure;

FIG. 2 is a schematic diagram of front and rear panels in FIG. 1;

FIG. 3 is a structural schematic diagram of a crushing mechanism in FIG. 1.

In the drawings: 1—feed port; 2—crushing reaction chamber; 3—crushing mechanism; 31—stirring shaft; 32—blade; 33—vent hole; 4—heating mechanism; 5—infrared temperature measuring device; 6—laser range finder; 7—ash slag outlet; 8—ash slag vibration system; 9—exhaust gas purification system; 10—negative pressure fan; 11—exhaust gas recycling mechanism.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

An objective of the present disclosure is to provide a magnetization pyrolysis device for organic waste and using method thereof. In the present disclosure, the crushing zone is combined with the reaction zone, which significantly reduces treatment space and cost. In-situ degradation of household waste can be achieved by the device without leaving the village, and the daily cleaning of everyday rural waste can be effectively achieved.

To make the objectives, features and advantages of the present disclosure more obvious and easier to understand, the following further describes the present disclosure in detail with reference to the accompanying drawings and the specific embodiments.

### Embodiment 1

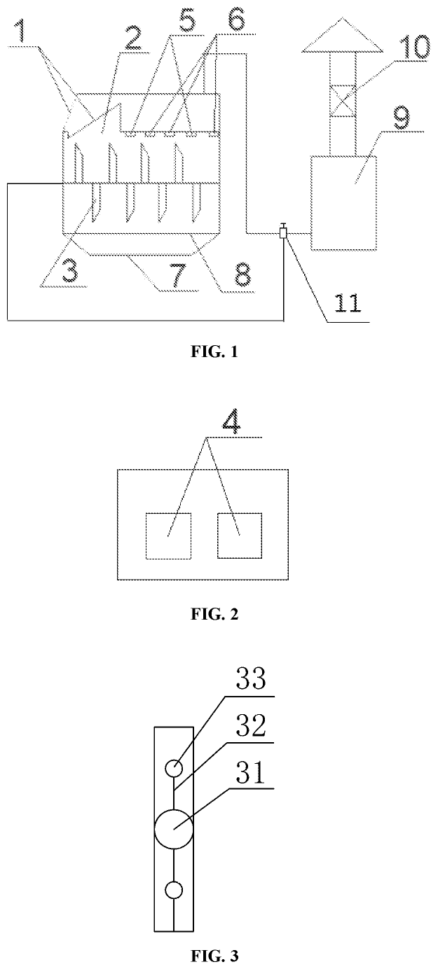

Please referring to FIG. 1 to FIG. 3, a magnetization pyrolysis device for organic waste configured for magnetization pyrolysis process of the organic waste using perovskite as a catalyst according to this embodiment is provided, the magnetization pyrolysis device includes a crushing reaction chamber 2 combining a crushing zone with a reaction zone; a crushing mechanism 3 for crushing the organic waste; and a heating mechanism 4 for heating the organic waste, the crushing mechanism and the heating mechanism are arranged in the crushing reaction chamber 2.

The crushing mechanism 3 includes: a stirring shaft 31 traversing the crushing reaction chamber 2, both ends of the stirring shaft 31 are rotatably installed on two opposite side walls of the crushing reaction chamber 2; and blades 32 for cutting up the waste, uniformly arranged on an outer circumference of the stirring shaft 31. A power mechanism, such as a motor, is used to drive the stirring shaft 31 to rotate, and the stirring shaft 31 drives the blades 32 thereon to rotate so as to cutting up the waste while stirring.

Exhaust gas circulation channels are formed inside the stirring shaft 31 and the blades 32 and are in communication with each other. Vent holes 33 for communicating the exhaust gas circulation channels with outside, i.e., the crushing reaction chamber 2, are formed in the blades 32.

An exhaust gas outlet for discharging exhaust gas produced during reaction, is formed at a top of the crushing reaction chamber 2, the exhaust gas outlet is in communication with an exhaust gas purification system 9 by a pipeline, and the exhaust gas purification system 9 is connected to a negative pressure fan 10 for extracting the exhaust gas from the crushing reaction chamber 2. An exhaust gas recycling mechanism 11 is arranged on the pipeline between the exhaust gas outlet and the exhaust gas purification system 9, and the exhaust gas recycling mechanism 11 is in communication with the exhaust circulation channel in the stirring shaft 31 by the pipeline. As such, the exhaust gas produced in the crushing reaction chamber 2 flows out from the exhaust gas outlet, most of the exhaust gas flowing to the exhaust gas purification system 9 is purified and evacuated, and a small part of the exhaust gas flowing to the exhaust gas recycling mechanism 11 is transported to the exhaust gas circulation channel in the stirring shaft 31, and then flows out through the vent holes 33 in the blades 32 and returns to the crushing reaction chamber 2, forming a cycle and providing a suitable micro-oxygen environment for the degradation of organic waste in the crushing reaction chamber 2. The exhaust gas purification system 9 and the exhaust gas recycling mechanism 11 in the above solution are existing in the prior art, and any technical solution capable of achieving this function in the prior art can be used, so the details are not repeated here.

A heating mechanism 4 includes an electromagnetic induction heating assembly to achieve electromagnetic degradation of organic waste. An electromagnetic field for electromagnetic degradation is preferably generated by an electromagnetic field generator, and a magnetic field generated by the electromagnetic field generator is preferably a high-frequency magnetic field with a magnetic field intensity is preferably 2 T-5 T, and more preferably 3 T-4 T. Limiting the magnetic field intensity within the above range can ensure that the electromagnetic degradation has a proper heating rate, so as to accelerate the reaction.

A laser range finder 6 and an infrared temperature measuring device 5 are arranged in an upper part of the crushing reaction chamber 2. The laser range finder 6 is configured to monitor the amount of waste added each time, e.g., when the height of waste poured into the crushing reaction chamber 2 reaches a certain value, the laser range finder 6 gives a warning of stopping adding. The infrared temperature measuring device 5 is configured to monitor the temperature of organic materials during electromagnetic heating. When the temperature of the organic material reaches the temperature of electromagnetic degradation, the electromagnetic field generator stops generating high-frequency magnetic fields, and when the temperature of the organic material is lower than the temperature of electromagnetic degradation, the electromagnetic field generator automatically starts.

An ash slag vibration system 8 is arranged at a lower part of the crushing reaction chamber 2, and the ash slag vibration system is configured to discharge the produced ash slag from an ash slag outlet 7. The ash slag vibration system 8 is existing in the prior art, and any technical solution capable of achieving this function in the prior art can be used, so the details are not repeated here.

### Embodiment 2

A using method of the magnetization pyrolysis device for organic waste according to this embodiment is provided, the using method includes the following steps:
Step (1) turning on the negative pressure fan 10 and the exhaust gas recycling mechanism 11 to maintain the exhaust gas purification system in a micro-oxygen state, opening a feed port 1 of the crushing reaction chamber 2, pouring collected household waste mixture into the crushing reaction chamber 2 in batches until a height of the waste mixture is 20 cm-30 cm higher than that of the crushing mechanism 3, and mixing the household waste mixture with a perovskite catalyst;
Step (2) closing the feed port 1, and turning on the crushing mechanism 3 for 3-7 min;
Step (3) turning off the crushing mechanism 3, turning on the electromagnetic induction heating assembly to enable the organic waste to perform self-heating by electromagnetic radiation;
Step (4) detecting a reaction temperature by the infrared temperature measuring device 5, and turning off the electromagnetic induction heating assembly when the reaction temperature reaches a certain temperature, and turning on the electromagnetic induction heating assembly when the reaction temperature is lower than the certain temperature;
Step (5) maintaining the heating reaction for 20 h-24 h; and
Step (6) turning off the negative pressure fan 10, the exhaust gas recycling mechanism 11, and the electromagnetic induction heating assembly, opening the feed port 1 for feeding, and repeating the above steps.

A preparation method for the perovskite catalyst used in Step (1) is as follows:
Step a. mixing potassium nitrate, magnesium nitrate, calcium nitrate, binder and water to obtain a mixed solution;
Step b. mixing the mixed solution obtained in Step a with sodium hydroxide solution for precipitation reaction, so as to obtain a precursor; and
Step c. Aging and calcining the precursor obtained in Step b in sequence, so as to obtain the perovskite catalyst.

In Step a, mass ratio of potassium nitrate to magnesium nitrate to calcium nitrate to binder is (0.01-0.03):(0.6-1.25):(0.1-0.3):(0.1-0.75), which is beneficial for the preparation of subsequent precursor and provides a good foundation for the preparation of the catalyst.

In Step b, temperature of the precipitation reaction is 50-75° C., and pH value of the precipitation reaction is 8-9. The coprecipitation of ions in the mixed solution can be guaranteed, the uniformity of the precursor is improved, and the catalytic performance of the final catalyst is further improved.

### Application Case 1

A preparation method for the perovskite catalyst according to this application case is provided, the preparation method includes the following steps:
Step a. stirring potassium nitrate, magnesium nitrate, calcium nitrate, binder and water for 5 min at 60° C. and a rotational speed of 600 rpm, so as to obtain a mixed solution;
   mass ratio of potassium nitrate to magnesium nitrate to calcium nitrate to binder is 0.01:0.8:0.1:0.3, and ratio of mass of potassium nitrate to volume of water is 0.01 mol:5.5 L;
Step b. mixing the mixed solution obtained in Step a with 1 mol/L sodium hydroxide solution at a rotational speed of 300 rpm under a stirring condition, and then precipitation reaction is conducted at 65° C. to obtain a precursor;
   pH value of the precipitation reaction is 9, and the sodium hydroxide solution accounts for 6.5% of the volume of the mixed solution;
Step c. aging the precursor obtained in Step b in a vacuum drying oven for 12 h at 80° C. and then calcining at 550° C. for 3 h in a muffle furnace under a vacuum condition, and finally grinding to obtain a perovskite catalyst;
   particle size of the perovskite catalyst is 1 mm.

### Application Case 2

A using method of the magnetization pyrolysis device for organic waste, using the perovskite catalyst in application case 1, according to this application case is provided, the using method includes the following steps:
Step (1) turning on the negative pressure fan 10 and the exhaust gas recycling mechanism 11 to maintain the exhaust gas purification system in a micro-oxygen state with oxygen concentration of 0.03 ml/L, opening a feed port 1 of the crushing reaction chamber 2, pouring collected household waste mixture consisting of glass bottles, metal bottles, kitchen waste, waste paper, nylon and woodwork into the crushing reaction chamber 2 in batches until a height of the waste mixture is 30 cm higher than that of crushing blades, and mixing the household waste mixture with the perovskite catalyst, amount of the perovskite catalyst added accounts for 2.5% of mass of the organic waste;
Step (2) closing the feed port 1, and turning on the crushing mechanism 3 for 6 min to crush the waste to 1.4 mm.
Step (3) turning off the crushing mechanism 3, turning on the electromagnetic induction heating assembly to enable the organic waste to perform self-heating by means of electromagnetic radiation.
Step (4) detecting reaction temperature by the infrared temperature measuring device 5, and turning off the electromagnetic induction heating assembly when the reaction temperature reaches 200° C., and turning on the electromagnetic induction heating assembly when the reaction temperature is lower than 200° C.;
Step (5) maintaining the heating reaction for 18 h.
Step (6) turning off the negative pressure fan 10, the exhaust gas recycling mechanism 11 and the electromagnetic induction heating assembly, turning on an ash slag vibration system 8, and turning off the ash slag vibration system 8 after the ash slag is discharged from the ash slag vibration system, opening the feed port 1 for feeding, and repeating above steps.

The gas produced during degradation is purified by the exhaust gas purification system 9 (water washing and spraying, electrical tar precipitator and low-temperature plasma) and then discharged when the Standard for pollution control on the municipal solid waste incineration (GB 18485-2014) is met.

Loss on ignition of the ash slag produced from electromagnetic degradation of organic waste is 3%.

After electromagnetic degradation of the organic waste, the perovskite catalyst is mixed with the ash slag and then is discharged with the progress of reaction, and an inorganic catalyst is recycled and reused by applying a magnetic field.

The results of electromagnetic degradation of the organic waste in application case 1-2 show that the perovskite catalyst provided in the present disclosure, when applied to the electromagnetic degradation of organic waste, can reduce the degradation temperature, shorten the degradation time, can complete the degradation of organic waste within 24 hours at 200° C.-250° C., and can reduce the temperature of electromagnetic degradation of organic waste, thus avoiding production of dioxins.

Adaptive changes made according to actual needs are within the scope of protection of the present disclosure.

It should be noted that it is apparent to those skilled in the art that the present disclosure is not limited to the details of the above exemplary embodiments, and can be realized in other specific forms without departing from the spirit or basic characteristics of the present disclosure. Therefore, the embodiments should be considered as exemplary and non-limiting in all aspects, and the scope of the present disclosure is defined by the appended claims rather than the above description, so it is intended to embrace all changes that fall within the meaning and range of equivalents of the claims. Any reference signs in the claims should not be regarded as limiting the claims involved.

What is claimed is:

1. A magnetization pyrolysis device for organic waste, configured for magnetization pyrolysis process of the organic waste using perovskite as a catalyst, the magnetization pyrolysis device comprises a crushing reaction chamber combining a crushing zone with a reaction zone; a crushing mechanism for crushing the organic waste; and a heating mechanism for heating the organic waste, the crushing mechanism and the heating mechanism are arranged in the crushing reaction chamber.

2. The magnetization pyrolysis device for organic waste according to claim 1, wherein the crushing mechanism comprises a stirring shaft traversing the crushing reaction chamber, and blades uniformly arranged on an outer circumference of the stirring shaft; exhaust gas circulation channels are formed inside the stirring shaft and the blades and are in communication with each other; Vent holes for communicating the exhaust gas circulation channels with outside are formed in the blades.

3. The magnetization pyrolysis device for organic waste according to claim 2, wherein an exhaust gas outlet is formed at a top of the crushing reaction chamber, the exhaust gas outlet is in communication with an exhaust gas purification system for purifying exhaust gas by a pipeline, and the exhaust gas purification system is connected to a negative pressure fan for extracting exhaust gas from the crushing reaction chamber.

4. The magnetization pyrolysis device for organic waste according to claim 3, wherein an exhaust gas recycling mechanism is arranged on the pipeline between the exhaust gas outlet and the exhaust gas purification system, the exhaust gas recycling mechanism is in communication with the exhaust circulation channel in the stirring shaft.

5. The magnetization pyrolysis device for organic waste according to claim 4, wherein the heating mechanism comprises an electromagnetic induction heating assembly, and the electromagnetic induction heating assembly forms a high-frequency magnetic field with a neodymium magnet by alternating voltage.

6. The magnetization pyrolysis device for organic waste according to claim 5, wherein an infrared temperature measuring device and a laser range finder are arranged on an upper part in the crushing reaction chamber.

7. A using method of a magnetization pyrolysis device for organic waste,
the magnetization pyrolysis device for organic waste comprises a crushing reaction chamber combining a crushing zone with a reaction zone; a crushing mechanism for crushing the organic waste; and a heating mechanism for heating the organic waste, the crushing mechanism and the heating mechanism are arranged in the crushing reaction chamber;
the crushing mechanism comprises a stirring shaft traversing the crushing reaction chamber, and blades uniformly arranged on an outer circumference of the stirring shaft; exhaust gas circulation channels are formed inside the stirring shaft and the blades and are in communication with each other; vent holes for communicating the exhaust gas circulation channels with outside are formed in the blades;
an exhaust gas outlet is formed at a top of the crushing reaction chamber, the exhaust gas outlet is in communication with an exhaust gas purification system for purifying exhaust gas by a pipeline, and the exhaust gas purification system is connected to a negative pressure fan for extracting exhaust gas from the crushing reaction chamber;
an exhaust gas recycling mechanism is arranged on the pipeline between the exhaust gas outlet and the exhaust gas purification system, the exhaust gas recycling mechanism is in communication with the exhaust circulation channel in the stirring shaft;
the heating mechanism comprises an electromagnetic induction heating assembly, and the electromagnetic induction heating assembly forms a high-frequency magnetic field with a neodymium magnet by alternating voltage;
an infrared temperature measuring device and a laser range finder are arranged on an upper part in the crushing reaction chamber; and
the using method comprising the following steps:
Step (1) turning on the negative pressure fan and the exhaust gas recycling mechanism to maintain the exhaust gas purification system in a micro-oxygen state, opening a feed port of the crushing reaction chamber, pouring collected household waste mixture into the crushing reaction chamber in batches until height of the waste mixture is 20 cm-30 cm higher than that of the crushing mechanism, and mixing the household waste mixture with a perovskite catalyst;
Step (2) closing the feed port, and turning on the crushing mechanism for 3 min-7 min;
Step (3) turning off the crushing mechanism, turning on the electromagnetic induction heating assembly to enable the organic waste to perform self-heating by electromagnetic radiation;
Step (4) detecting reaction temperature by the infrared temperature measuring device, and turning off the electromagnetic induction heating assembly when the reaction temperature reaches a certain temperature, and turning on the electromagnetic induction heating assembly when the reaction temperature is lower than the certain temperature;
Step (5) maintaining heating reaction for 20 h-24 h; and
Step (6) turning off the negative pressure fan, the exhaust gas recycling mechanism, and the electromagnetic induction heating assembly, opening the feed port for feeding, and repeating above steps.

8. The using method according to claim 7, wherein the reaction temperature is 200° C.-250° C.

9. The using method according to claim 8, wherein amount of the perovskite catalyst added accounts for 1%-5% of mass of the organic waste.

10. The using method according to claim 8, wherein oxygen concentration in the micro-oxygen state is 0.01 ml/L-0.1 ml/L.
